(19) United States
(12) Patent Application Publication
(10) Pub. No.: US 2005/0078602 A1
(43) Pub. Date: Apr. 14, 2005

(54) Method and apparatus for allocating bandwidth at a network element

(75) Inventors: Timothy Mancour, Wrentham, MA (US); Michael Loomis, Greenland, NH (US)

Correspondence Address: JOHN C. GORECKI, ESQ., 180 HEMLOCK HILL ROAD, CARLISLE, MA, 01741, US

(73) Assignee: Nortel Networks Limited, St. Laurent (CA)

(21) Appl. No.: 10/714,080

(22) Filed: Nov. 14, 2003

Related U.S. Application Data
(60) Provisional application No. 60/510,474, filed on Oct. 10, 2003.

(51) Int. Cl. H04L 1/00

(52) U.S. Cl. 370/230; 370/235; 370/412

(57) ABSTRACT

Packets in a Per Hop Basis (PHB) are metered by a network element to see if they fall within a Committed Information Rate (CIR) or Committed Burst Size (CBS) for that PHB. Packets that are within the CIR or CBS for the given PHB are marked as in profile. Packets to be output over a given port that are not in profile are metered by a common Surplus Information Rate (SIR) meter, which is used to meter commonly excess packets from all PHBs configured through that port. By using a common SIR meter to meter out of profile packets for all PHBs on a given port, it is possible to allow packets from multiple PHBs to share the surplus bandwidth on a link connected to that port fairly, while not allocating bandwidth to PHBs that do not require surplus bandwidth. Token buckets may be used to implement the meters.

### CROSS REFERENCE TO RELATED APPLICATIONS

This application is a continuation in part of prior Provisional U.S. Patent Application No. 60/510,474, filed Oct. 10, 2003, the content of which is hereby incorporated herein by reference.

### BACKGROUND OF THE INVENTION

1. Field of the Invention

The present invention relates to communication networks and, more particularly, to a method and apparatus for allocating bandwidth at a network element.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

2. Description of the Related Art

Data communication networks may include various computers, servers, nodes, routers, switches, hubs, proxies, and other network devices coupled to and configured to pass data to one another. These devices will be referred to herein as “network elements.” Data is communicated through the data communication network by passing data packets (or data cells, frames, or segments) between the network elements by utilizing one or more communication links between the devices. A particular packet may be handled by multiple network elements and cross multiple communication links as it travels between its source and its destination over the network.

The various network elements on the communication network communicate with each other using predefined sets of rules, referred to herein as protocols. Multiple protocols exist, and are used to define aspects of how the communication network should behave, such as how the computers should identify each other on the network, the form that the data should take in transit, and how the information should be reconstructed once it reaches its final destination. Two such protocols of interest herein are commonly referred to as Transmission Control Protocol (TCP) and Internet Protocol (IP).

Subscribers and network providers typically contract for bandwidth on the network by specifying the committed information rate—how much bandwidth the network provider is committed to providing that subscriber. The network provider and subscriber may also specify other contract parameters, such as the peak information rate (PIR), which defines the maximum amount of information a sender may send at a given time. Additionally, within these specified rates, there may be different classes of service, such as Expedited Forwarding (EF), assured forwarding (AF), and any other class of service desired by the participants. The class of service may be specified in the differentiated services (DS) field in the IP header of packets to be transmitted on the network as is discussed in greater detail in Internet Engineering Task Force (IETF) Request For Comments (RFC) 2474, the content of which is hereby incorporated herein by reference.

Data traveling over a network on a given Transmission Control Protocol (TCP) session is generally considered a microflow. A microflow may be used, for example, to transmit a file from one computer to another computer over a communication network. All packets on a microflow will be assigned a particular Class of Service (CoS). Groups of microflows with the same CoS associated with the same Service Level Agreement (SLA) are used to form Per Hop Behavior (PHB) groups. PHB groups will also be referred to herein as “PHBs.” Multiple PHBs may be transmitted over a single interface onto a communication link by a network element.

Since traffic in a particular PHB is to be treated different from traffic in other PHBs (according to the subscriber's SLA and the particular CoS of the group) network elements must be configured to differentiate and treat each PHB individually. One common way to do this is to use an individual exit queue in a network element for each PHB. A given PHB therefore may be assumed to map to a given queue in a network element. For example, a given subscriber may have traffic that is expedited forwarding traffic. This traffic would fall within one PHB and would be mapped to a given exit queue. Other traffic for the subscriber may be classified as assured forwarding 1 or assured forwarding 2, and would be handled as another PHB and mapped to another exit queue. Where both PHBs are to be transmitted over the same interface, both exit queues are thus associated with one interface and may be serviced by the interface in a round robin fashion or using another arbitration algorithm.

Network providers meter the PHBs to classify traffic as falling within the committed information rate, peak information rate, or as excess traffic. This is sometimes referred to as coloring the traffic. Traffic that is within the committed information rate is colored green, traffic that is in excess of the committed information rate but able to be transmitted by the switch is colored yellow, and any remaining traffic is colored red. Ideally, a network element would transmit green traffic for all PHBs and then allow all of the PHBs to share any excess bandwidth by coloring the excess traffic in a fair manner. Although the invention will be described herein in connection with coloring traffic into green, yellow, and red classifications, other ways of describing the same concept may be utilized as well, such as marking the traffic with a low, medium and high drop preference. Accordingly, other terminology may be used as well and the selected terminology is not to be considered limiting the applicability of the invention.

One conventional way to meter traffic is to implement a two rate three color marker meter for each PHB supported by the network element. One drawback to this is that this solution requires the use of a considerable amount of physical memory. For example, there may be 8 PHBs concurrently transmitting over a given port on a network element. If token buckets are used to implement a two rate three color marker for each PHB, it is necessary to implement 16 token buckets to meter traffic over the port. Taking into account that a network element may support thousands of PHBs over many output ports, this number quickly escalates. Thus, implementation of a separate two rate three color meter for each PHB may thus require a considerable amount of physical memory.

Additionally, using separate meters to allocate portions of the excess bandwidth to PHBs does not allow the excess bandwidth to be shared fairly. For example, if each PHB on a port is allocated a certain amount of excess bandwidth, PHBs with no excess data to transmit will be allocated bandwidth on the link connected to that port unnecessarily. This solution thus results in under-utilization of the excess bandwidth. Similarly, allowing each PHB to transmit data at a higher rate may cause over-subscription of the excess bandwidth on the link since more than one PHB may be bursting data simultaneously. Accordingly, using separate meters per PHB does not allow multiple PHBs to share the surplus bandwidth efficiently and fairly as each separate meter will color the traffic independent of the other meters, thus potentially resulting in either too much yellow traffic or too much red traffic. Accordingly, it would be advantageous to provide a new way to allocate bandwidth at a network element.

### SUMMARY OF THE INVENTION

The present invention overcomes these and other drawbacks by providing a method and apparatus for allocating bandwidth at a network element. According to one embodiment, packets in a PHB are metered to see if they fall within a committed information rate for that PHB. Packets that are within the CIR for the given PHB are colored green. Packets that are outside the CIR are metered by a surplus information rate meter, which is used to meter commonly excess packets from the PHBs configured to be output over that port or logical port. As used herein, the term “port” will be defined as including both physical and logical ports. Many types of logical ports exist, such as Frame Relay Data Link Connection Identifiers (DLCIs), Time Division Multiplexing (TDM) channels, Virtual LANs (VLANs), bundles of flows, link aggregations, and numerous other types of logical associations of bandwidths or logical apportioning of bandwidths. The term port is thus not limited to any particular type of logical port. By metering the surplus packets together on a per-port basis it is possible to ensure fair treatment to the PHBs while not over-committing network or network element resources. By using a common meter to meter packets falling outside their PHBs' committed information rates, it is possible to allow packets from multiple PHBs to share the surplus bandwidth on a port equally as needed, while not allocating bandwidth to PHBs that do not have a need for use of the surplus bandwidth.

According to an embodiment of the invention, individual token buckets are used to meter packets belonging to each PHB. If there are sufficient tokens in the token bucket for the PHB for a given packet, the packet is marked green and placed in the queue for transmission. If there are not sufficient tokens in the token bucket the packet is passed to a surplus information rate (SIR) token bucket. The SIR token bucket is shared by all PHBs on a link such that all packets that have not been marked green that are to be transmitted on the link are sent to the SIR token bucket for that interface. If there are sufficient tokens in the SIR token bucket to pass the packet the packet is marked yellow. If there are not sufficient tokens in the SIR token bucket the packet is marked red.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram of an example of a network architecture;

FIG. 2 is a functional block diagram of a network element according to an embodiment of the invention;

FIG. 3 is a flowchart of an example of how a packet is handled by the network element illustrated in FIG. 2;

FIG. 4 is a functional block diagram of a packet meter for use in the embodiment of FIG. 2 according to an embodiment of the invention; and

FIG. 5 is a functional block diagram of a meter for use in the packet meter of FIG. 4 in greater detail, according to an embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

As described in greater detail below, the method and apparatus of the present invention enable packets in a multi-class flow to be metered per PHB and allow PHBs associated with a given link to share surplus bandwidth on the link fairly. According to one embodiment of the invention, packets not falling within a committed information rate for their respective PHB are metered together by a surplus information rate meter. By using a common meter to meter surplus packets destined to be transmitted on a given link, it is possible to allow packets from multiple PHBs to share the surplus bandwidth on the link equally as needed, while not allocating bandwidth to PHBs that do not have a need for use of the surplus bandwidth.

According to an embodiment of the invention, token buckets are used to meter packets belonging to each PHB to classify packets as falling within the committed information rate. If there are sufficient tokens in the token bucket for a given packet, the packet is marked green and placed in the queue for transmission. If there are not sufficient tokens in the token bucket the meter checks to see if there are there are sufficient tokens in the surplus information rate (SIR) token bucket for that link. The SIR token bucket is shared by all PHBs configured to transmit packets on the link such that all packets that have not been marked green are metered by the same SIR token bucket for that link. If there are sufficient tokens in the SIR token bucket to pass the packet the packet is marked yellow. If there are not sufficient tokens in the SIR token bucket the packet is marked red.

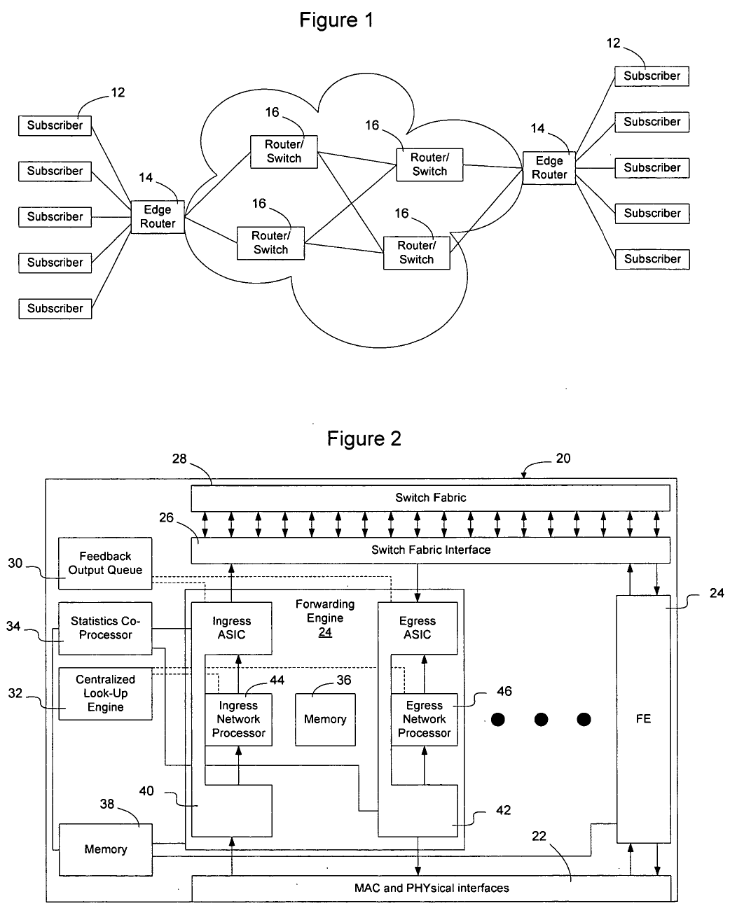

FIG. 1 illustrates one example of a communication network 10. As illustrated in FIG. 1, subscribers 12 access the network by interfacing with a network element such as an edge router 14 or other construct typically operated by an entity such as an internet service provider, telephone company, or other connectivity provider. The edge router collects traffic from the subscribers and multiplexes the traffic onto the network backbone, which includes multiple routers/switches 16 connected together. Through an appropriate use of protocols and exchanges, data may be exchanged with another subscriber or resources may be accessed and passed to the subscriber 12. Aspects of the invention may be utilized in the edge routers 14, routers/switches 16, or any other network element utilized on communications network 10.

FIG. 2 illustrates one embodiment of a network element 20 that may be configured to implement embodiments of the invention. The invention is not limited to a network element configured as illustrated, however, as the invention may be implemented on a network element configured in many different ways. The discussion of the specific structure and methods of operation of the embodiment illustrated in FIG. 2 is intended only to provide one example of how the invention may be used and implemented in a particular instance. The invention more broadly may be used in connection with any network element configured to meter packets on a communications network. The network element of FIG. 2 may be used as an edge router 14, a router/switch 16, or another type of network element on a communication network such as the communication network described above in FIG. 1.

As shown in FIG. 2, a network element 20 generally includes interfaces 22 configured to connect to links in the communications network. The interfaces 22 may include physical interfaces, such as optical ports, electrical ports, wireless ports, infrared ports, or ports configured to communicate with other conventional physical media, as well as logical elements configured to operate as MAC (layer 2) ports.

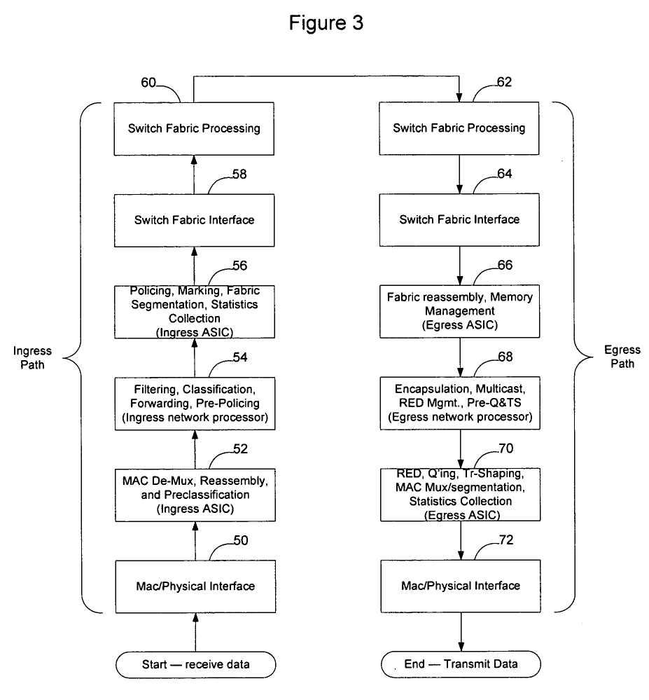

One or more forwarding engines 24 are provided in the network element to process packets received over the interfaces 22. A detailed description of the forwarding engines 24 and the functions performed by the forwarding engines 24 will be provided below in connection with FIG. 3.

The forwarding engine 24 forwards packets to the switch fabric interface 26, which passes the packets to the switch fabric 28. The switch fabric 28 enables a packet entering on one of the interfaces 22 to be output at a different interface 22 in a conventional manner. A packet returning from the switch fabric 28 is received by the forwarding engine 24 and passed to the interfaces 22. The packet may be handled by the same forwarding engine 24 on both the ingress and egress paths. Optionally, where more than one forwarding engine 24 is included in the network element 20, a given packet may be handled by different forwarding engines on the ingress and egress paths.

The forwarding engines may be supported by one or more elements configured to perform specific functions to enhance the capabilities of the network element. For example, the network element may include a feedback output queue element 30 configured to assist in queue management, a centralized look-up engine 32 configured to interface memory tables to assist in routing decisions, and a statistics co-processor 34 configured to gather statistics and put them in Management Information Base (MIB)-readable form. The MIB and other software for use by the forwarding engine 24 or by the network element 20 may be maintained in internal memory 36 or external memory 38. The invention is not limited to any particular interface 22, forwarding engine 24, switch fabric interface 26, or switch fabric 28, but rather may be implemented in any suitable network element configured to meter packets on data flows through a network. One or more Application Specific Integrated Circuits (ASICs) 40, 42 and processors 44, 46 may be provided to implement instructions and processes on the forwarding engines 24.

FIG. 3 illustrates in greater detail the processes performed on a packet as the packet passes through the network element of FIG. 2. These processes may be implemented in software, firmware, or hardware, or a combination thereof. The invention is not limited to processing packets as similar operations may take place on segments, frames, or other logical associations of bits and bytes of data. As shown in FIG. 3, in this embodiment, packets generally travel through the forwarding engine two times—utilizing an ingress path and utilizing an egress path. Packet metering may be done on either the ingress path or the egress path, or optionally in tandem on both paths. Generally, metering will be performed on the ingress path, although the invention is not limited in this manner.

As shown in FIG. 3, on the ingress path, data arrives at the MAC/PHYsical interface 22 (50) and is passed to the ingress ASIC (Application Specific Integrated Circuit) 40. The ingress MAC device receives data from the PHY device that provides the physical interface for a particular interface or set of supported interfaces. After physical reception and checking, the MAC device transfers packets to the ingress ASIC 40.

The ingress ASIC 40 pre-processes the data by de-multiplexing the data, reassembling packets, and preclassifying the packet (52). In one embodiment, the ingress ASIC responds to fullness indications from the MAC device and transfers complete packets to the ingress network processor 44. It services contending MAC interfaces in a round robin fashion, or utilizing any other conventional arbitration scheme. Optionally, packets arriving at the MAC interface may be buffered prior to being transferred to the ingress network processor.

The ingress ASIC may preclassify packets to accelerate processing of the packets in later stages by other constructs within the network element. According to one embodiment, the ingress ASIC examines the MAC and EP headers and records a variety of conditions to assist the ingress network processor 44 in processing the packets. For example, the ingress ASIC may examine the MAC address of the packet, may identify the protocol or protocols being used in formation and/or transmission of the packet, and examine the packet for the presence of a congestion notification. The results of the preclassification are prepended to the packet in preamble.

The packet is then forwarded to the ingress network processor 44. The ingress network processor 44 implements rules to make filtering decisions for packets meeting particular criteria, classifies the packet, makes initial policing decisions, and makes forwarding decisions associated with the packet (54).

For example, in one embodiment, the ingress network processor executes lookups in coordination with the centralized lookup engine 32, performs filtering and classification operations, and modifies the IP and MAC headers within the body of the packet to reflect routing and switching decisions. The ingress network processor also creates information that is not contained within the packet but that is needed to complete the packet processing. This information is may be placed in the packet preamble or within the packet header.

The ingress network processor identifies an account to be used for policing and marking by the ingress ASIC. Optionally, policing and marking could take place in the ingress network processor, although in the illustrated embodiment policing and marking takes place at a later stage by the ingress ASIC. In the illustrated embodiment, the ingress network processor determines the packets class and records it in three QoS bits. The ingress network processor may also determine its marking and record it in out of profile indicators associated with the packet. This marking is subsequently used by and may be overwritten by the policing function and/or the congestion dialog.

The ingress network processor 38 also determines the information needed by the switch fabric to carry the packet to the correct egress point. For example, the ingress network processor may ascertain the TAP, PID (slot address and subaddress) and the physical egress port to which the packet is to be routed/switched. Optionally, the ingress network processor may determine and record the egress queue ID as part of the lookup process and pass it to the egress processor (discussed below) to further facilitate end-to-end QoS.

The packet is then passed back to the ingress ASIC 40 which implements the policing and filtering decisions, marks the packet according to the packet classification, and performs packet segmentation to prepare packets to be passed to the switch fabric interface 26 (56). In one embodiment, policing and marking of each packet are performed against one or more credit mechanisms such as token buckets. Following this function, a dialog takes place with a congestion manager (not shown) to determine the packet's disposition. As a result of this dialog, the packet may be dropped or re-marked by overwriting the out of profile indicators. The packet may also be dropped or modified if warranted.

The packet is then segmented for the fabric. The cell and packet headers and trailers are completed and formatted. The packet preamble may be discarded at this stage as the information contained in the packet preamble is no longer needed by the ingress ASIC or ingress network processor. Once the packets are segmented, the packets are passed to the switch fabric interface 26 (58) and then to the switch fabric 28 for processing (60). The switch fabric transports the packet from its ingress point to the egress point (or points) defined by the ingress network processor.

On the egress path, after the packet has exited the switch fabric 28 (62) the packet is passed back to the switch fabric interface (64), which passes the packet to the egress ASIC 42. The egress ASIC 42 reassembles the packet (if it was segmented prior to being passed to the switch fabric 28) and performs memory management to manage output queues (66). During reassembly, the information in the cell headers and trailers is recorded in a packet preamble. A packet header extension may be present and, if so, is passed to the egress network processor. The memory requirements for reassembly are determined by the number of contexts, packet size, and potential bottleneck(s) to the egress network processor due to, for example, whether the packet or other packets are to be multicast, etc. Following reassembly, packets are queued for output to the egress network processor 46. Packets are retrieved from the egress queues for processing according to any arbitration scheme.

The packet is then passed to the egress network processor 46 which performs multiple functions associated with preparing the packet to be again transmitted onto the network. For example, the egress network processor 46 may encapsulate the packet, perform operations to enable the packet to be multicast (transmitted to multiple recipients), perform Random Early Drop (RED) management, and perform initial queuing and traffic shaping operations (68). Specifically, the egress network processor uses the MAC and IP packet headers, along with the QoS bits to classify the packet into a PHB so that it may be metered on a per-PHB basis during the queuing and traffic shaping operations. This information is coded in the packet preamble.

11 The packet is then passed to the egress ASIC to be metered and queued prior to being passed to the MAC/PHYsical interfaces 22 for re-transmission onto the network (70). In addition to queuing packets, the egress ASIC performs traffic shaping by metering the packets, as described in greater detail below. Counters may be maintained in the egress ASIC to enable statistics to be gathered from the queues, on a per-PHB basis, or from any other metric of interest. The amount of memory required to store packets prior to transmission onto the network depends on many factors, such as the desired queue lengths, the number of queues (PHBs) supported per port, and the amount of time information must be maintained in the queue for potential retransmission. The amount of time packets should be maintained in a queue may be determined, in a TCP network, in a known fashion by ascertaining the round trip time (TCP-RTT).

The packets are then passed to the MAC/PHYsical interfaces 22 for retransmission onto the network (72). The MAC interface multiplexes the packet onto the physical interface that places the data onto the link to be transmitted to another network element.

According to an embodiment of the invention, the egress network processor and/or egress ASIC implement a packet meter to enable packets in each PHB to be metered individually to assure each PHB is allocated an appropriate amount of bandwidth so that packets falling within the committed information rate for each PHB are marked green and are allocated bandwidth on the output link. Additionally, packets to be transmitted over a given link that are not marked green by the PHB meters are metered by a shared surplus information rate meter associated with that link so that surplus packets from each PHB may have fair access to the surplus bandwidth on the link.

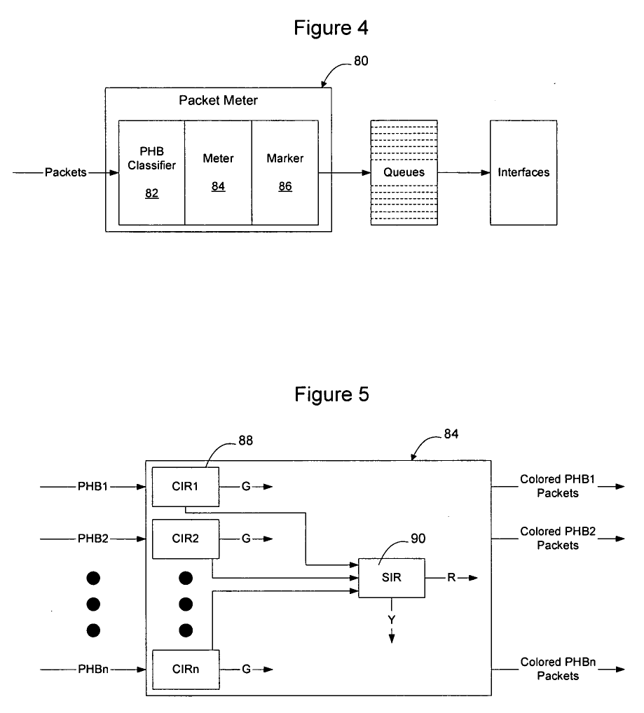

FIG. 4 illustrates one embodiment of the invention in which a packet meter, configured to implement embodiments of the invention, has three stages: a classify stage, a meter stage, and a marker stage. The classify, meter, and marker functions may be performed by the ingress ASIC, the ingress processor, the egress ASIC or the egress processor in the embodiments described above. Optionally, different functions may be performed by more than one stage or by different stages of the network element. The invention is not limited to where in the network element the functions are performed as they may be performed at any stage or combination of stages in the network element. In one embodiment, the classify, meter and marker functions are associated with the egress processor 46 and egress ASIC 42, although the invention is not limited to this embodiment. The classify function, meter function, and marker function, as well as an embodiment for implementing these functions, will be described in greater detail below in connection with FIGS. 4-5.

In the embodiment illustrated in FIG. 4, the packet meter 80 includes a PHB classifier 82 configured to classify input packets into PHB groups, a meter 84 configured to meter the packets on each PHB group according to their CIR, and to meter packets from all groups to enable the packets from all PHBs associated with a given port to share the surplus bandwidth on the port; and a marker 86 configured to mark the packets according to the decision made by the classifier and meter. In the following description, an embodiment will be described in which the protocol data units being handled the meter are IP packets. The invention is not limited to operating on EP packets, however, as other protocol data units (PDU) may similarly be metered according to the invention.

Initially, packets are classified into PHBs using the PHB classifier 82. In one embodiment of the invention, where the packet meter is configured to operate on IP packets, the PHB classifier may be configured to extract the PHB parameter from the Differentiated Services field of the incoming IP packet. Other embodiments may look at other aspects of the protocol data units (PDUs) being handled by the network element to ascertain the PHB into which the PDU should be classified. Information about the differentiated services field and the implementation of differentiated services in IPv4 and IPv6 is contained in Internet Engineering Task Force (IETF) Request For Comments (RFC) 2474, the content of which is hereby incorporated herein by reference.

The PHB classifier may be configured to operate in either color aware mode or color blind mode. When operating in color aware mode, the color is also extracted from the DS field using a per PHB procedure. Otherwise, when operating in color blind mode, the color is set to green. It is assumed that the classify function will only emit PHB identifiers that are supported by the meter and marker functions. Unrecognized PHB identifiers may be grouped together and assigned a default PHB to enable them to be handled by the network element.

Once the packets have been classified into PHBs, the packets are passed to the meter 84. One embodiment of a meter that may be used in connection with the packet meter 80 is illustrated in FIG. 5 and discussed in greater detail below. The meter 84 uses the incoming IP packet length, PHB, and color to determine the “metered color” that is associated with the IP packet. A packet that exceeds both its committed information rate for that PHB and exceeds the surplus information rate (SIR) for the port over which it will be transmitted. will be assigned a color of red. A packet that exceeds its CIR for that PHB but does not exceed the SIR for the port will be assigned a color of yellow. A packet that does not exceed its CIR will be assigned a color of green. Note that the CIR for a given PHB could be set to zero, for example where the PHB corresponds to a best effort class of service, so that there may never be any green packets for a particular PHB.

The marker, like the PHB classifier, operates in either color aware mode or color blind mode. When operating in color aware mode, this function will recolor the DS field of the IP packet using a PHB specific encoding and the “metered color” parameter that was emitted by the classful meter 84.

FIG. 5 illustrates one embodiment of a meter that may be configured to implement the functions ascribed to meter 84 to meter packets to be transmitted over a given port. According to one embodiment of the invention, one meter will be provided for each port connected to the network element. As shown in FIG. 5, the meter 84 includes a committed information rate token bucket 88 for each PHB associated with the port to enable packets for each PHB to be metered independently. This allows the committed information rate for each PHB to be specified individually and to assure that packets received on each PHB will be classified as green traffic if there is sufficient bandwidth allocated to that PHB within its committed information rate to transmit that packet on the port.

Token buckets are commonly used to meter packets or other units of data flowing through a network element. A token bucket system works such that a certain number of tokens are added to the token bucket each time period, or tick. When a packet or segment of data arrives, the network element checks to see if there are sufficient tokens in the token bucket to transmit the packet or segment of data. Depending on the size of the packet or segment, a different amount of tokens may be required.

The frequency with which the token bucket is filled, referred to herein as the tick rate, the number of tokens that are added each tick, referred to herein as the fill rate, the amount of data permitted to be passed for each token, and the maximum size of the token bucket, are all matters that may be adjusted to meet the specific needs of a particular system. For example, adding a large number of tokens infrequently will enable bursty traffic to pass through the system right after the tokens have been added. However, this depletion of tokens in the bucket may deprive other higher priority traffic from being passed as the bucket is depleted toward the end of the tick cycle.

By increasing the tick rate and reducing the fill rate, the bucket is more likely to be at least partially filled throughout so that high priority traffic will generally be able to be passed by the network element. Conversely, this relatively constant input of fewer numbers of tokens may affect the network element's ability to effectively transmit bursty traffic.

Increasing the maximum size of the token bucket will allow a greater number of tokens to amass in the token bucket, and hence allow the network element to accommodate larger bursts of traffic. If the token bucket is too large, however, this may cause problems for the network as a whole by causing an unduly large number of collisions on the network, and by denying other network elements the resources they have paid for.

Each token can represent any arbitrary amount of data. For example, in an IP network a token may represent an IP packet or a byte of data in an IP packet. Since EP packets are of variable length, it is believed preferable to utilize a token that represents a fixed value, such as a bit of data or a byte of data, to enable the network element to monitor and control more closely the total amount of traffic being transmitted onto the network.

The invention is not limited to the use of any particular token bucket implementation, as the specific selected values for the adjustable parameters, e.g. the tick rate, the fill rate, etc., may be adjusted to meet the needs of the particular network. According to one embodiment of the invention, the token buckets for the committed information rate are specified in terms of octets of EP packets per second. The invention is not limited in this manner, however, as other specifications may be used as well.

The CIR token buckets 88 according to one embodiment of the invention are provided with two parameters, a fill rate and a maximum size. The fill rate corresponds to how fast the bucket is filled, and is related to the committed information rate. The faster the bucket is filled the more tokens may be used on an on-going basis to transmit packets, and hence the larger the committed information rate for that PHB. The CIR token buckets are also configured with a maximum size, which correlates to the peak information rate for that PHB. The peak information rate is used to allow the network element to accommodate data bursts on the PHBs without causing an excess number of packets to be dropped for bursty traffic where there is overall a relatively low amount of traffic on that PHB.

In addition to including a token bucket to meter packets on a per PHB basis, packets that cannot be passed given the current token levels in the respective CIR token buckets, are passed to a second token bucket represented by the SIR token bucket 90. The SIR token bucket is provided to meter packets onto the surplus bandwidth on the port, so that each PHB configured to be transmitted on the port is able to transmit packets on the surplus bandwidth. By using a single token bucket in this embodiment to meter packets from all PHBs associated with the port, each PHB is able to share equally in the surplus bandwidth.

According to one embodiment of the invention, each meter 84 is thus configured with several parameters: a committed information rate for each supported PHB (CIR) and a committed burst size (CBS) for each supported PHB, which are used to set the parameters of the token buckets for each PHB. Additionally, the meter 84 is configured with a surplus information rate (SIR) which is used to set the tic rate for the SIR token bucket, and a surplus burst size (SBS) which is used to set the size of the SIR token bucket.

Both the SIR and the CIR parameters are given in octets of IP packets per second. The SBS and CBS parameters are given in octets. It is presently preferred that these later parameters be set to be equal to or greater than the maximum IP packet size that is supported by the packet stream so that the largest packets are able to be passed by the meters—if the token buckets are too small to pass the largest packets, those packets will never be passed by the network element.

During operation, each classful meter maintains the number of octets (or token counts) that are currently associated with the SIR parameter and each of the individual CIR parameters. The value of the token count that is associated with the SIR parameter is represented using the notation Ts. The value of the token count that is associated with each CIR[phb] will be represented using the notation TC[phb].

Upon initialization, all of the token buckets are set to be full. This is accomplished by initializing the value of SIR token bucket (Ts) to be equal to surplus burst size SBS and each of CIR token bucket values TC[phb] to be equal to their respective committed burst size CBS. After initialization is complete, the values of the token buckets are incremented at the associated information rate or tic rate. Specifically, the SIR token bucket value is incremented by a value corresponding to the surplus information rate (Ts value is incremented by one SIR per second), and each CIR token bucket is incremented by the committed information rate for that token bucket (TC[phb] values are incremented by one CIR[phb] per second). The token bucket values are limited by the maximum token bucket size, however, to prevent a given PHB from bursting too much data at once and to prevent the surplus from bursting too much data at once. Accordingly, in this example, the Ts value cannot exceed the value of the SBS parameter. Similarly, none of the Tc[phb] values may exceed the value of the CBS parameter.

The classful meter performs the following for each IP packet of length L (in octets of bytes) that is received:

```
if (Tc[phb] < L) /* This packet is in excess of the CIR. */
{
      if (Ts < L) /* This packet is in excess of the SIR. */
      {
          metered_color = RED;
      }
      else
      {
          Ts=Ts-L;
          metered_color = MAX_COLOR (color, YELLOW);
      }
}
else
{
      Tc[phb] =Tc[phb]-L
      metered_color = MAX_COLOR(color, GREEN);
}
```

In this software code, the meter first checks to see if the length of the packet is larger than the number of tokens in the token bucket for that PHB. Although in this example the length of the packet has been compared, other embodiments may use other metrics to meter the packets, and the invention is not limited to metering packets using the packet length information. If there are sufficient tokens in the token bucket for that PHB, the token bucket will be decremented by the length of the packet (Tc[phb]=Tc[phb]−L) and the metered color for that packet will be set to green.

If there are insufficient tokens in the token bucket for that PHB to pass the packet (Tc[phb]<L), the packet is in excess of the committed information rate for that CIR. The meter then checks to see if it is possible to pass the packet in the surplus bandwidth on the port. To do this it looks to see if there are sufficient tokens in the SIR token bucket to pass the packet. If there are not, and the length is greater than the number of tokens in the token bucket (Ts<L), the packet is in excess of the surplus information rate and will be marked red. If there are sufficient tokens in the token bucket to pass the packet, the SIR token bucket will be decremented by the length of the packet (Ts=Ts−L) and the packet color will be marked yellow.

Although an embodiment has been described using token buckets to meter the packets, other embodiments may use other meters to regulate which packets are marked as green and yellow. The MAX_COLOR macro in this code may be defined such that red has a greater value than yellow, and such that yellow has a greater value than green. This macro may be defined in a number of other ways depending on how it is configured to interact with the other software running on the network element, however, and the invention is not limited to this particular example definition of this macro. Additionally, although the packets have been described as being marked green/yellow/red, the invention is not limited to this embodiment as the packets may be marked in any desired fashion. These labels therefore are not to be used in a limiting sense, but rather to facilitate understanding of the invention. Accordingly, the invention is not limited to a network element or to a method that is used to filter packet flows labeled green and yellow.

The functions described above may be implemented as a set of program instructions that are stored in a computer readable memory within the network element and executed on one or more processors within the network element. However, it will be apparent to a skilled artisan that all logic described herein can be embodied using discrete components, integrated circuitry, programmable logic used in conjunction with a programmable logic device such as a Field Programmable Gate Array (FPGA) or microprocessor, a state machine, or any other device including any combination thereof. Programmable logic can be fixed temporarily or permanently in a tangible medium such as a read-only memory chip, a computer memory, a disk, or other storage medium. Programmable logic can also be fixed in a computer data signal embodied in a carrier wave, allowing the programmable logic to be transmitted over an interface such as a computer bus or communication network. All such embodiments are intended to fall within the scope of the present invention.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

1. A method of allocating bandwidth at a network element, the method comprising the steps of:
metering first traffic for a first Per Hop Basis group (PHB) to ascertain first in-profile traffic for the first PHB;
metering second traffic for a second PHB to ascertain second in-profile traffic for the second PHB; and
commonly metering first traffic that has not been ascertained to be first in-profile traffic with second traffic that has not been ascertained to be second in-profile traffic to ascertain commonly metered traffic.

2. The method of claim 1, wherein the bandwidth allocated by the method is bandwidth on one or more links connected to a port of the network element, and wherein the first traffic and second traffic are configured to be transmitted through the port.

3. The method of claim 2, wherein the bandwidth is allocated to the first in-profile traffic, the second in-profile traffic, and wherein any surplus bandwidth not consumed by the first in-profile traffic and second in-profile traffic is allocated to the commonly metered traffic.

4. The method of claim 1, further comprising the step of classifying incoming traffic into the first traffic and the second traffic.

5. The method of claim 1, further comprising marking the first in-profile traffic with a first designation, marking the second in-profile traffic with the first designation, and marking at least a first portion of the commonly metered traffic with a second designation.

6. The method of claim 5, further comprising marking at least a second portion of the commonly metered traffic with a third designation.

7. The method of claim 1, wherein the step of metering the first traffic is performed using a first token bucket and wherein the ascertained first in-profile traffic for the first PHB is a portion of the first traffic for which there is sufficient tokens in the first token bucket;
wherein the step of metering the second traffic is performed using a second token bucket and wherein the ascertained second in-profile traffic for the second PHB is a portion of the second traffic for which there is sufficient tokens in the second token bucket; and
wherein the step of commonly metering is performed using a third common token bucket and wherein the ascertained commonly metered traffic is a portion of the first traffic that has not been ascertained to be first in-profile traffic and second traffic that has not been ascertained to be second in-profile traffic for which there is sufficient tokens in the third common token bucket.

8. The method of claim 7, wherein the first token bucket is provided with no tokens so that the ascertained first in-profile traffic for the first PHB is set to zero.

9. The method of claim 7, further comprising the steps of:
coloring green the portion of the first traffic for which there is sufficient tokens in the first token bucket;
coloring green the portion of the second traffic for which there is sufficient tokens in the second token bucket; and
coloring yellow the portion of the commonly metered traffic for which there is sufficient tokens in the third common token bucket.

10. The method of claim 9, further comprising the step of:
coloring red a portion of the commonly metered traffic for which there is not sufficient tokens in the third common token bucket.

11. A packet meter, comprising:
a Per Hop Behavior (PHB) classifier; and
a meter configured to meter in-profile packets on a PHB basis and out-of-profile packets on a common basis.

12. The packet meter of claim 11, further comprising a marker configured to mark packets metered by the meter.

13. The packet meter of claim 11, wherein the meter is configured to apply bandwidth allocation rules on a PHB basis to allocate bandwidth to each PHB based on its associated bandwidth allocation rule.

14. The packet meter of claim 13, wherein the bandwidth allocation rules comprise at least a committed information rate and a committed burst rate.

15. The packet meter of claim 13, wherein the meter is configured to meter out-of-profile packets on a common basis by allocating surplus bandwidth.

16. The packet meter of claim 11, wherein the meter comprises:
a first plurality of token buckets, said first plurality of token buckets being configured to allocate bandwidth to PHBs on a per-PHB basis; and
a common token bucket configured to meter out-of-profile packets on a per-port basis.

17. The packet meter of claim 16, further comprising a marker, said marker being configured to mark as green any packet that was passed by one of the first plurality of token buckets, and said marker being configured to mark as yellow any packet that was passed by the common token bucket.

18. The packet meter of claim 17, wherein the marker is further configured to mark as red any packet that was not passed by one of the first plurality of token buckets and not passed by the common token bucket.
